(19) United States
(12) Patent Application Publication
(10) Pub. No.: US 2011/0107361 A1
(43) Pub. Date: May 5, 2011

(54) OPTICAL DISC DEVICE

(76) Inventors: Sojiro KIRIHARA, Kawasaki (JP); Koji MATSUMOTO, Tokyo (JP); Hiroshi YAMAGISHI, Chiba (JP)

(21) Appl. No.: 12/915,900

(22) Filed: Oct. 29, 2010

(30) Foreign Application Priority Data
Oct. 30, 2009 (JP) 2009-250389

(51) Int. Cl. G11B 17/03

(52) U.S. Cl. 720/601; G9B/17.009

(57) ABSTRACT

In an optical disc device, the device effectively reduces noise generated during the time of optical disc revolution and at the same time prevents a tray and an optical disc placed on the tray from coming into contact with each other or a circuit board mounted on the tray from undergoing electrostatic destruction. A circuit board for controlling a spindle motor and a pickup is mounted on a tray for placing an optical disc on the reverse side of the rear area. There are formed through-holes crookedly piercing through the tray in the thickness direction in the rear area of the tray. The through-holes are so constructed that their openings on tray's reverse side are invisible from their openings on tray's face side.

### INCORPORATION BY REFERENCE

The present application claims priority from Japanese patent application serial No. JP 2009-250389, filed on Oct. 30, 2009, the content of which is hereby incorporated by reference into this application.

### BACKGROUND OF THE INVENTION

(1) Field of the Invention

The present invention relates to an optical disc device that effectively reduces noise generated by the revolution of an optical disc.

(2) Description of the Related Art

In recent optical disc devices, as the revolution of optical discs increases, generated noise also increases, thereby requiring any measures to reduce it. As for the mechanism of noise generation, it is assumed that airflow induced by a revolving disc hits a tray for placing the disc on or peripheral members to generate noise. It is therefore effective for noise reduction to attenuate this airflow and, as for the structure of a tray, there are made such proposals as follows:

Japanese Unexamined patent publication serial No. 2001-52405 discloses a structure in which rugged portions with a height of 0.1 mm or above are formed on a tray surface at least in part thereof or a structure in which cilia or spongy members are disposed on a tray surface at least in part thereof. The literature describes that airflow loses the velocity through contact with these rugged portions and cilia. The literature also describes that sound-absorbing function of the cilia helps reduce noise.

Japanese Unexamined patent publication serial No. 2003-85964 discloses a structure in which a plurality of openings (through-holes) are formed at the rear of a tray. Airflow generated during the time of disc revolution is supplied through these openings to a circuit board placed on the reverse side of the tray to dissipate heat out of heat-generating components on the board. Although Japanese Unexamined patent publication serial No. 2003-85964 aims at dissipation of heat, it also promises an effect of reducing noise by letting airflow go to the reverse side of the tray through these holes.

### SUMMARY OF THE INVENTION

In an attempt to obtain thinner type of devices, optical disc devices for use in personal computers have optical discs placed on (or over to be exact) trays in proximity within a predetermined distance to them. In the case of Japanese Unexamined patent publication serial No. 2001-52405, projections of rugged portions on a tray narrow a space between a disc surface and a tray surface, thereby having a possibility that the disc surface and the tray surface come into contact with each other to do damage to the disc surface. It is the same with the structure in which cilia or spongy members are disposed.

In an attempt to simplify wiring between a tray and the main body of a device, the latest optical disc devices also adopt a so-called PCB-integrated structure in which a printed circuit board (PCB) is mounted directly on the reverse side of a tray. In the tray of PCB-integrated structure like this, to have such through-holes as is described in Japanese Unexamined patent publication serial No. 2003-85964 gives rise to the problem of electrostatic discharge (ESD), that is to say, when static electricity should arrive from outside during the state where a tray has been drawn, the electricity could discharge an electric current through the intermediary of through-holes toward electronic components on the PCB at the back of the tray, thereby causing a possible destruction thereof.

It is, therefore, an object of the present invention to provide an optical disc device that can effectively reduce noise generated during the time of optical disc revolution and at the same time has no possibility that a tray and an optical disc placed on the tray come into contact with each other, or a circuit board mounted on a tray undergoes electrostatic destruction.

The invention provides an optical disc device for recording information on an optical disc or playing it back comprising a tray for placing the optical disc on at the time of loading or unloading the optical disc, a spindle motor for holding and revolving the optical disc on the tray, a pickup for recording or playing back information by radiating a laser beam on the optical disc, and a circuit board for controlling the spindle motor and the pickup, wherein the circuit board is mounted on the tray on the reverse side of a rear area, and at the same time a through-hole crookedly piercing through the tray in the thickness direction is formed at least in the rear area of the tray. Here, the through-hole formed on the tray is so constructed that the greater part of one opening is invisible from the other opening.

The present invention can effectively reduce noise generated during the time of optical disc revolution. At that time, there is no possibility that a disc and a tray placing the disc on come into contact with each other, or a circuit board mounted on the tray undergoes electrostatic destruction, and hence a practically excellent optical disc device is obtained.

### BRIEF DESCRIPTION OF THE DRAWINGS

These and other features, objects and advantages of the present invention will become more apparent from the following description when taken in conjunction with the accompanying drawings wherein:

FIG. 1 is an exploded view in perspective of an optical disc device as a whole showing one embodiment of the device according to the present invention.

FIG. 2A is a top plan view showing the structure of a tray in this embodiment.

FIG. 2B is a sectional view taken along the line A-A of FIG. 2A, showing the structure of through-holes provided on a tray.

FIG. 3A is a top plan view showing the structure of a tray in the past as a comparative example.

FIG. 3B is a sectional view taken along the line B-B of FIG. 3A, showing the structure of through-holes in the past as a comparative example.

FIG. 4 is a top plan view showing another structure of through-holes provided on a tray.

FIG. 5A is a top plan view showing still another structure of through-holes provided on a tray.

FIG. 5B is a top plan view showing still more another structure of through-holes provided on a tray.

### DETAILED DESCRIPTION OF THE EMBODIMENT

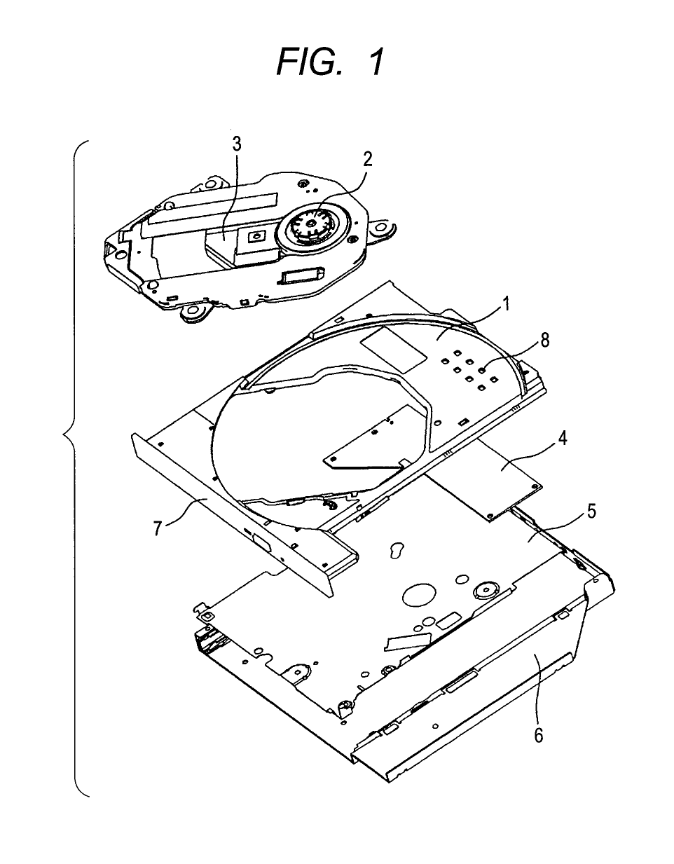

Hereinafter, embodiments of the present invention will be described with reference to the accompanying drawings. FIG. 1 is an exploded view in perspective of an optical disc device as a whole showing one embodiment of the device according to the present invention. The optical disc device is constituted by assembling a tray 1 for placing an optical disc on at the time of loading or unloading the optical disc, a spindle motor 2 for holding and revolving the optical disc on the tray 1, a pickup 3 for recording or playing back information by radiating a laser beam on the optical disc, a circuit board (PCB) 4 for controlling the spindle motor 2 and the pickup 3, bottom cover 5, and a bottom case 6. Note that FIG. 1 omits an optical disc and a top cover.

The circuit board 4 is fixed with screws to the tray 1 on the reverse side of the rear area, thereby constituting a so-called PCB-integrated structure. The front of the tray 1 has a front panel 7 for user operation and the rear area of the tray 1 has a large number of through-holes 8 formed for reducing noise. It means that at least part of the through-holes 8 are placed face to face with the circuit board 4. The through-holes 8 have a shape peculiar to this embodiment, the structure of which will be described later.

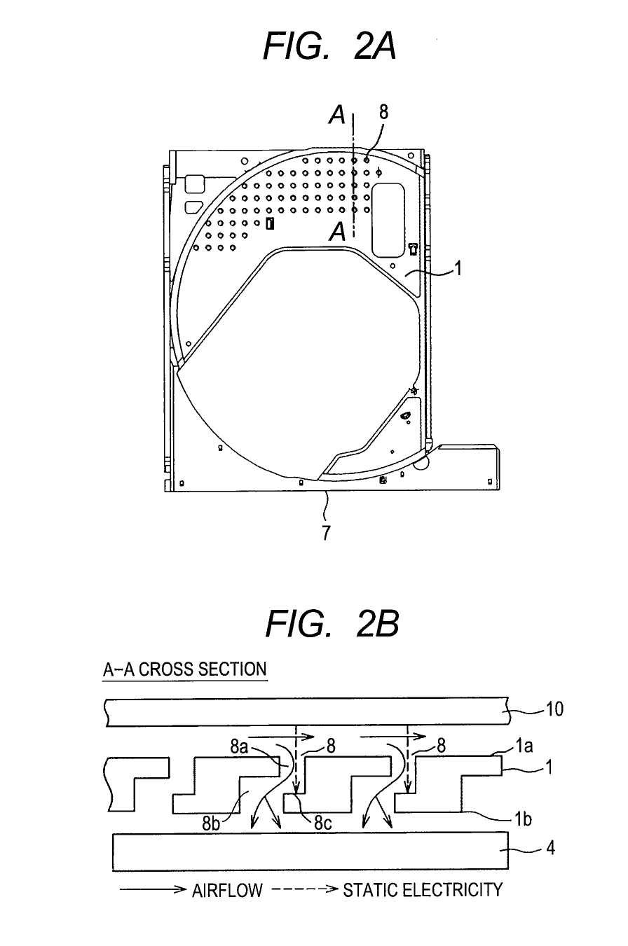

FIG. 2A is a top plan view showing the structure of a tray in this embodiment. There are formed a number of circular through-holes 8 in the rear area of the tray 1. Referring to one example of dimensions, through-holes 8 of approximately 2 mm in diameter are two-dimensionally formed on a tray 1 of 1 to 3 mm thick at intervals of 5˜6 mm. The rear of the tray 1, which is enclosed more hermetically than the front thereof (the side of a front panel 7), makes it hard for airflow generated by disc revolution to go out, thereby causing noise volume to grow. That is why we had the through-holes 8 in the rear area of the tray 1 prior to other areas.

FIG. 2B is a sectional view showing the structure of through-holes provided on a tray. Although the through-holes 8 pierce through the tray 1 in the thickness direction, they are so constructed that their direction is crooked on the way in the shape of a crank. It is so constructed that, thanks to the shape like a crank, one opening of the through-holes 8 is invisible from the other opening thereof.

Such through-holes 8 can be formed in the way as follows for example: First, a recess (an opening) 8a, which is deep enough to equal approximately ⅔ of the thickness of the tray 1, is formed from the side of disc-placing surface in the tray 1 (a tray face 1a). Secondly, a recess (an opening) 8b, which is similarly deep enough to equal approximately ⅔ of the thickness of the tray 1, is formed conversely from the side of mounting surface of a circuit board 4 in the tray 1 (the reverse side of the tray 1b). At that time, both (the recesses 8a and 8b) are formed with their locations out of alignment by a predetermined amount (substantially the diameter of the recesses) to form the shape of a crank in which their border is pierced through. Since this structure has through-holes 8 formed within the thickness of an original tray 1, a space between an optical disc and a tray, far from becoming narrow, is kept as it was and does not change. As a result, there is no possibility that a disc and a tray placing the disc on come into contact with each other.

FIG. 2B schematically illustrates the flow of air and static electricity. On one hand, airflow induced by the revolution of a disc 10 is sucked into through-holes 8 provided on a tray 1 to meet resistance. A part of the sucked air then flows down through the intermediary of through-holes 8 toward the side of a circuit board 4. As a result, air that flows along a space between the disc and the tray loses flow velocity, and hence noise is reduced. On the other hand, static electricity that arrives from above the tray 1 can go into the through-holes 8. Thanks to the through-holes 8 in the shape of a crank, however, the static electricity, which travels in a straight line, is blocked by the bottom 8c of a recess 8a, thereby failing to reach a circuit board 4. As a result, electric components on the circuit board 4 are protected from static electricity.

Note that the sectional shape of the through-holes 8 is not restricted to the one of a crank. Any through-hole will have a similar effect of preventing electrostatic destruction as far as the recess (opening) 8b or the greater part of the recess (opening) 8b on tray's reverse side is so constructed as to be invisible from the recess (opening) 8a on tray's face side.

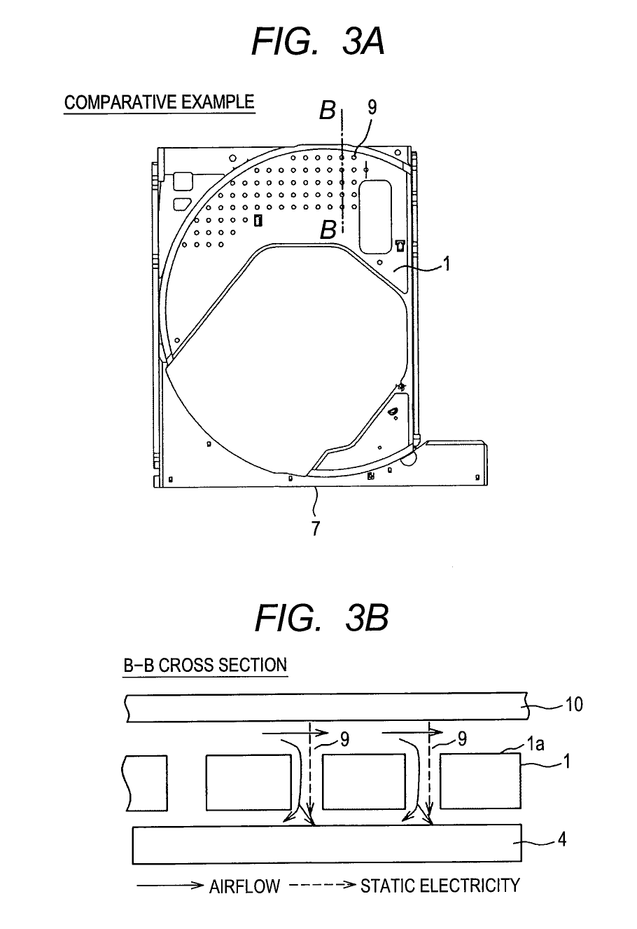

FIG. 3A is a top plan view showing the structure of a tray in the past as a comparative example and FIG. 3B is a sectional view showing the structure of through-holes in the past as a comparative example.

There are formed a number of circular through-holes 9 in the rear area of the tray 1. As is illustrated in FIG. 3B, these through-holes 9 pierce straight through the tray 1 in the thickness direction. While in the drawing these through-holes 9 pierce through the tray 1 in the direction perpendicular to the disc-placing surface 1a, they can be adapted to pierce through the tray 1 in the oblique direction as well.

FIG. 3B schematically illustrates the flow of air and static electricity. Airflow induced by the revolution of a disc 10 is sucked into through-holes 9 to meet resistance and a part thereof then flows down through the intermediary of the through-holes 9 toward the side of a circuit board 4. As a result, air that flows along a space between the disc and the tray loses the flow velocity, and hence noise is reduced. On the other hand, static electricity that arrives from above the tray 1 goes into the through-holes 9 and keeps traveling in a straight line to reach the circuit board 4. As a result, the static electricity charges an electric current toward electrical components on the circuit board 4, thereby causing a possible destruction of the electrical components. Note that formation of oblique through-holes cannot avoid electrostatic destruction since there exists static electricity arriving from the oblique direction.

In this way, the structure of having straight through-holes on a tray, while it is effective for reducing noise, still has the problem of electrostatic destruction. By contrast, the through-hole structure according to this embodiment, which structure is illustrated in FIGS. 2A and 2B, is effective for reducing noise and at the same time eliminates a danger of electrostatic destruction, and hence it helps obtain a practically excellent optical disc device.

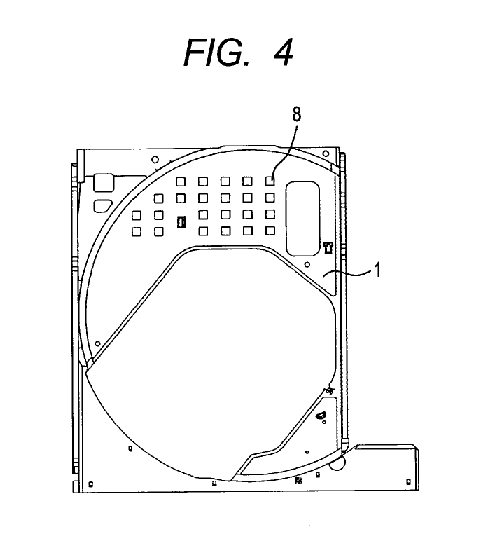

In this embodiment, the shape of through-holes provided on a tray is susceptible of various changes and some of the variations will be shown hereinafter: FIG. 4 is a top plan view showing another structure of through-holes provided on a tray. In this variation, the openings of through-holes 8 are formed in a square. In this case too, the direction of the holes, similarly to the one in FIG. 2B, is so constructed as to be crooked in the shape of a crank in the thickness direction of a tray, allowing air to flow down toward the reverse side of the tray. Thus, the holes have the effect of reducing noise and preventing electrostatic destruction. It will be needless to say that, as for the shape of openings, there can be various ones besides this including an oval, a rectangle, or any polygon.

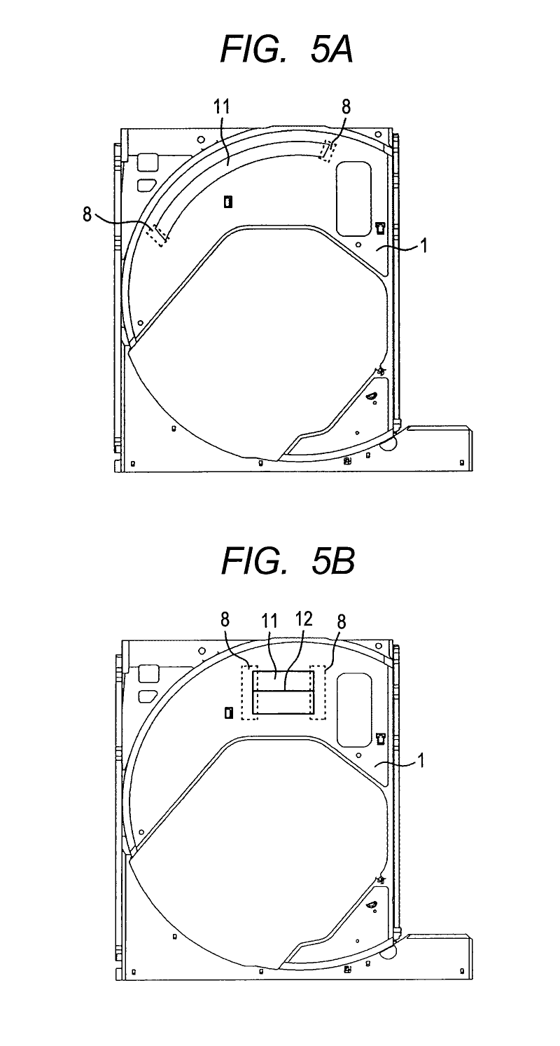

FIGS. 5A and 5B are top plan views showing still another structure of through-holes provided on a tray. In these variations, besides forming through-holes 8 on a tray 1, the through-holes 8 are so constructed as to be joined to non-piercing recesses 11. In FIG. 5A, a tray 1 has on the disc-placing surface an arcuate recess 11 and through-holes 8 which are joined to the arcuate recess 11 at both ends. In other words, it is so constructed that airflow, after having been pulled into the recess 11, goes through the holes 8 to reach the reverse side of the tray.

In FIG. 5B, a tray 1 has on the disc-placing surface a rectangular recess 11 and through-holes 8 which are joined to the rectangular recess 11 on the both sides. In this case, the bottom of the recess 11 has level difference 12 in the shape of the steps so that the depth of the recess 11 may be shallow on disc's inner-circumferential side and deep on disc's outer-circumferential side. In this case too, airflow, after having been pulled into the recess 11, can go through the holes 8 to reach the reverse side of the tray 1.

In this way, the structure joining through-holes 8 and a recess 11 together, which can pull much more airflow into the recess 11, can greatly attenuate airflow between a disc and a tray, thereby increasing noise reduction effect.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disc device for recording information on an optical disc or playing it back comprising:
a tray for placing the optical disc on at the time of loading or unloading the optical disc,
a spindle motor for holding and revolving the optical disc on the tray,
a pickup for recording or playing back information by radiating a laser beam on the optical disc, and
a circuit board for controlling the spindle motor and the pickup,
wherein the circuit board is mounted on the tray on the reverse side of rear area, and at the same time a through-hole crookedly piercing through the tray in thickness direction is formed at least in the rear area of the tray.

2. The optical disc device according to claim 1,
wherein the through-hole formed on the tray is so constructed that the greater part of one opening is invisible from the other opening.

3. The optical disc device according to claim 1,
wherein a large number of the through-holes are formed on the tray, at least part of the through-holes being placed face to face with the circuit board.

4. The optical disc device according to claim 1,
wherein the through-hole formed on the tray is joined to a non-piercing recess formed on the disc-placing surface of the tray.
